(19) United States
(12) Patent Application Publication
(10) Pub. No.: US 2012/0227308 A1
(43) Pub. Date: Sep. 13, 2012

(54) POLYGONAL ROD

(76) Inventor: Masaki TAKEMOTO, Niigata (JP)

(21) Appl. No.: 13/089,784

(22) Filed: Apr. 19, 2011

(30) Foreign Application Priority Data
Mar. 9, 2011 (JP) 2011-051822

(51) Int. Cl. A01K 87/00; B32B 1/08

(52) U.S. Cl. 43/18.1 R; 428/398

(57) ABSTRACT

The present invention relates to a polygonal rod in which a columnar body is provided between angled portions of a rod body, the polygonal rod having improved usability by swinging the rod body along a longitudinal direction of the columnar body. The polygonal rod includes four V-shaped longitudinal members (A, B) and a pair of flat-plate-like longitudinal members (C) to form a rod body (F) having a hexagonal shape, and further includes at least a pair of hollow portions (24, 25), in which a columnar body (21) is formed between angled portions (22, 22) of the rod body (F), and a longitudinal direction of the columnar body (21) is along a swinging direction (X) of the rod body (F), to thereby obtain the lightweight and rigid rod body (F).

### BACKGROUND OF THE INVENTION

1. Field of the Invention

The present invention relates to a polygonal rod, and more particularly, to a novel improvement for improving usability by providing a columnar body between angled portions of a rod body, and by swinging the rod body along a longitudinal direction of the columnar body.

2. Description of the Related Art

As examples of a polygonal rod of this type that has been conventionally used, conventional configurations illustrated in FIG. 19 to FIG. 24 can be given.

That is, although a document name is not described, the conventional configurations illustrated in FIG. 19 and FIG. 20 are generally used. FIG. 19 illustrates the solid configuration in which a plurality of trigonal longitudinal members 30 are densely joined together.

Further, FIG. 20 illustrates the hollow configuration in which a plurality of flat-plate-like longitudinal members C each having a trapezoidal shape in cross-section are joined together to form a hollow portion 25.

FIG. 21 illustrates the conventional configuration disclosed in JP 2010-124709 A, in which T-shaped longitudinal members 4 each having a T-shape in cross-section and the flat-plate-like longitudinal members C each having a trapezoidal shape in cross-section are combined together to form three hollow portions 25.

FIG. 22 illustrates the conventional configuration disclosed in “Present Bamboo Rod”, Toshosha, Jun. 11, 2007, p. 213, in which a pair of T-shaped longitudinal members 4 each having a T-shape in cross-section and the four flat-plate-like longitudinal members C are combined together to form a flattened hollow hexagonal rod.

FIG. 23 illustrates the conventional configuration disclosed in JP 2004-73167 A and JP 2002-159247 A, in which the four trigonal longitudinal members 30 each having a triangular shape in cross-section and a pair of trapezoidal longitudinal members each having a trapezoidal shape in cross-section are combined together to form a flattened solid hexagonal rod.

Although a document name is not described, FIG. 24 illustrates the conventional configuration in which the six T-shaped longitudinal members 4 are combined together to form a polygonal rod having a regular hexagonal shape.

The conventional polygonal rods have the configurations as described above, and hence the following problems are inherent therein.

Specifically, in the case of the solid hexagonal rod illustrated in FIG. 19, the rod is easily manufactured, but a weight of said rod is heavy, and hence it is impossible to respond to a request for quick movement.

Further, in the case of the hollow hexagonal column illustrated in FIG. 20, the column has a cross-section liable to be crushed when the rod is bent, and the column has a less rigid configuration.

Still further, in the case of the configuration of the hollow rod with three ribs illustrated in FIG. 21, in which the T-shaped longitudinal members are used to form the hollow portions, the rod has sufficient rigidity when swing vertically in the state of FIG. 21, but it is difficult for the rod to have sufficient rigidity when swing under a state in which an angled portion is directed forward.

Further, in the case of the flattened hexagonal rod with two ribs illustrated in FIG. 22, which includes two divided hollow portions, when the rod is swung vertically in the state of FIG. 22, rigidity is maintained, but air resistance is large and usability is not satisfactory.

Further, in the case of the solid flattened hexagonal rod illustrated in FIG. 23, air resistance is large, and lateral oscillation occurs when the rod is swung vertically under a state in which a lateral angled portion is directed forward. Thus, usability is not satisfactory.

Further, in the case of the hexagonal rod illustrated in FIG. 24, which uses the six T-shaped longitudinal members, the hollow portions are narrow, and hence it is difficult to reduce weight.

### SUMMARY OF THE INVENTION

According to the present invention, provided is a polygonal rod, which is formed into a longitudinal bar-like shape in overall view, and formed of a rod body having an outer periphery formed into a polygonal shape in cross-section, the polygonal rod including at least four first and second V-shaped longitudinal members each having a V-shape in cross-section, so as to form at least two hollow portions, in which the at least four first and second V-shaped longitudinal members are partially joined together to form a columnar body having a linear shape, and in which angled portions of the rod body are situated at both ends of the columnar body, respectively. Further, the polygonal rod further includes a flat-plate-like longitudinal member having a trapezoidal shape in cross-section between said four first and second V-shaped longitudinal members. Further, surface directions of a pair of connection surfaces formed in each of said four first and second V-shaped longitudinal members are one of the same direction and different directions. Further, the polygonal shape in cross-section includes a hexagonal shape in cross-section, and all of sides of the hexagonal shape in cross-section are equal or only two sides of the sides are shorter than the other sides. Further, said angled portion has a line guide for guiding a fishing line. Further, said first V-shaped longitudinal member and the flat-plate-like longitudinal member are formed by cutting a part of a trigonal longitudinal member having a regular triangular shape in cross-section. Further, the polygonal rod is configured so as to satisfy the following condition for a first height and a first width of the first V-shaped longitudinal member when a first connection surface of the first V-shaped longitudinal member is arranged to be directed upward, a second height and a second width of the second V-shaped longitudinal member when a first connection surface of the second V-shaped longitudinal member is arranged to be directed upward, and a third height and a third width of the trigonal longitudinal member having the regular triangular shape in cross-section before the flat-plate-like longitudinal member is formed: Ha=Hb=Hc and Wa=Wb=Wc, or Ha>Hb=Hc and Wa=Wb>Wc.

The polygonal rod according to the present invention can provide the following effects owing to the above-mentioned configurations.

Specifically, the polygonal rod is formed into a longitudinal bar-like shape in overall view, and formed of the rod body having the outer periphery formed into a polygonal shape in cross-section, the polygonal rod including the at least four V-shaped longitudinal members each having a V-shape in cross-section, so as to form the at least two hollow portions, in which the at least four V-shaped longitudinal members are partially joined together to form the columnar body having a linear shape, and in which the angled portions of the rod body are situated at both the ends of the columnar body, respectively. Thus, the rod can be swung along the longitudinal direction of the columnar body, have sufficient rigidity, and serve as a tapered surface along a swinging direction. Accordingly, it is possible to obtain the lightweight and strong hexagonal rod having no air resistance flap.

Further, the polygonal rod further includes the flat-plate-like longitudinal member having a trapezoidal shape in cross-section between said four V-shaped longitudinal members. Accordingly, it is possible to easily obtain the rod of a hexagonal column.

Further, the surface directions of the pair of connection surfaces formed in each of said four V-shaped longitudinal members are one of the same direction and different directions. Accordingly, it is possible to easily obtain the columnar body.

Further, the polygonal shape in cross-section includes a hexagonal shape in cross-section, and all of the sides of the hexagonal shape in cross-section are equal or only two sides of the sides are shorter than the other sides. Accordingly, it is possible to easily obtain the regular hexagonal rod and the flattened hexagonal rod each including the columnar body in the swinging direction.

Further, the angled portion includes the line guide for guiding a fishing line. Accordingly, it is possible to form the hexagonal rod including the columnar body in the swinging direction.

Further, the first V-shaped longitudinal member and the flat-plate-like longitudinal member are formed by cutting the part of the trigonal longitudinal member having a regular triangular shape in cross-section. Accordingly, it is possible to easily obtain the first V-shaped longitudinal member and the flat-plate-like longitudinal member.

Further, the polygonal rod is configured so as to satisfy the following condition for the first height and the first width of the first V-shaped longitudinal member when the first connection surface of the first V-shaped longitudinal member is arranged to be directed upward, the second height and the second width of the second V-shaped longitudinal member when the first connection surface of the second V-shaped longitudinal member is arranged to be directed upward, and the third height and the third width of the trigonal longitudinal member having the regular triangular shape in cross-section before the flat-plate-like longitudinal member is formed: Ha=Hb=Hc and Wa=Wb=Wc, or Ha>Hb=Hc and Wa=Wb>Wc. Accordingly, it is possible to freely produce the hexagonal rod including the columnar body in the swinging direction.

### BRIEF DESCRIPTION OF THE DRAWINGS

In the accompanying drawings:

FIG. 1 is a front view of a polygonal rod according to the present invention;

FIG. 2 is a front view illustrating another embodiment of the polygonal rod of FIG. 1;

FIG. 3 is a front view illustrating still another embodiment of the polygonal rod of FIG. 1;

FIG. 4 is a front view illustrating another embodiment of the polygonal rod of FIG. 3;

FIG. 5 is a front view of a main part of FIG. 1;

FIG. 6 is a front view of a main part of FIG. 1;

FIG. 7 is a front view of a main part of FIG. 1;

FIG. 8 is a perspective view of the polygonal rod according to the present invention;

FIG. 9 is a perspective view illustrating another embodiment of the polygonal rod of FIG. 8;

FIG. 10 is a perspective view illustrating still another embodiment of the polygonal rod of FIG. 8;

FIG. 11 is a perspective view illustrating another embodiment of the polygonal rod of FIG. 10;

FIG. 12 is an explanatory diagram illustrating a method of cutting out a trigonal longitudinal member according to the present invention;

FIG. 13 is an explanatory diagram illustrating a first V-shaped longitudinal member from the explanatory diagram of FIG. 12;

FIG. 14 is an explanatory diagram illustrating a method of cutting out a trigonal longitudinal member with a protrusion according to the present invention;

FIG. 15 is an explanatory diagram illustrating a state of cutting the trigonal longitudinal member with a protrusion of FIG. 14;

FIG. 16 is an explanatory diagram illustrating a state of cutting a second V-shaped longitudinal member according to the present invention;

FIG. 17 is an explanatory diagram illustrating cutting of the trigonal longitudinal member, which is a base material before processing a flat-plate-like longitudinal member according to the present invention;

FIG. 18 is an explanatory diagram illustrating a state of forming the flat-plate-like longitudinal member by cutting the trigonal longitudinal member of FIG. 17;

FIG. 19 is a perspective view of a conventional polygonal rod;

FIG. 20 is a perspective view illustrating another conventional example of the polygonal rod of FIG. 19;

FIG. 21 is a perspective view illustrating another conventional example of the polygonal rod of FIG. 20;

FIG. 22 is a perspective view illustrating another conventional example of the polygonal rod of FIG. 21;

FIG. 23 is a perspective view illustrating another conventional example of the polygonal rod of FIG. 22; and

FIG. 24 is a perspective view illustrating another conventional example of the polygonal rod of FIG. 23.

### DETAILED DESCRIPTION OF THE PREFERRED EMBODIMENTS

It is an object of the present invention to provide a polygonal rod in which a columnar body is provided between angled portions of a rod body, the polygonal rod having improved usability by swinging the rod body along a longitudinal direction of the columnar body.

### Embodiments

Hereinafter, preferred embodiments of a polygonal rod according to the present invention are described with reference to the drawings.

Note that, the same portions as those of the conventional examples are described while being denoted by the same reference symbols.

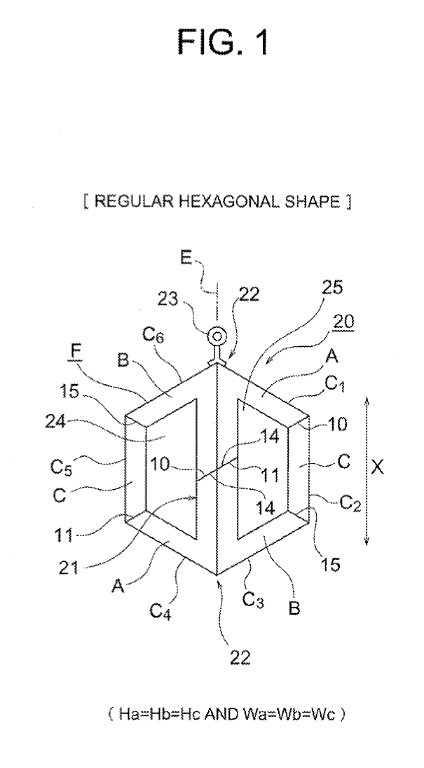

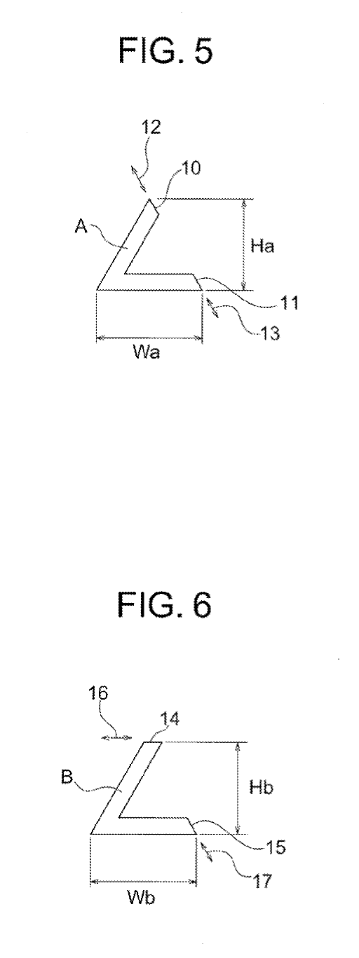

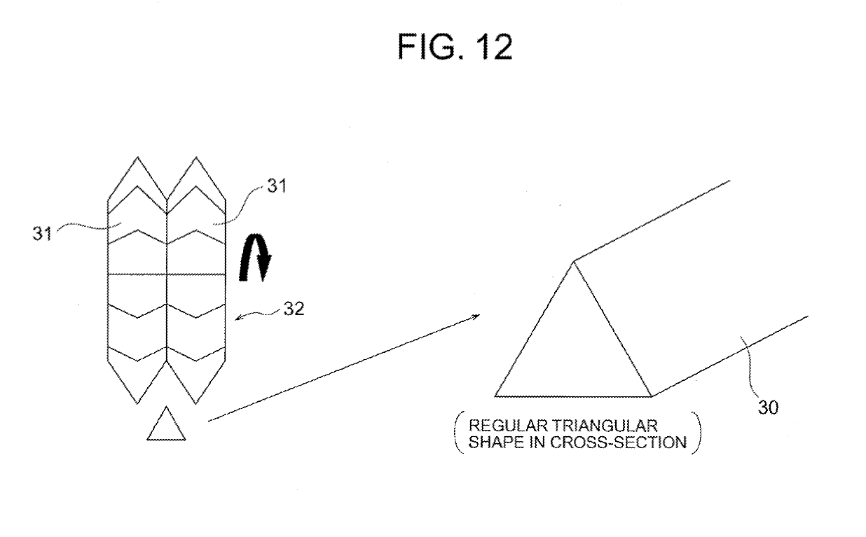

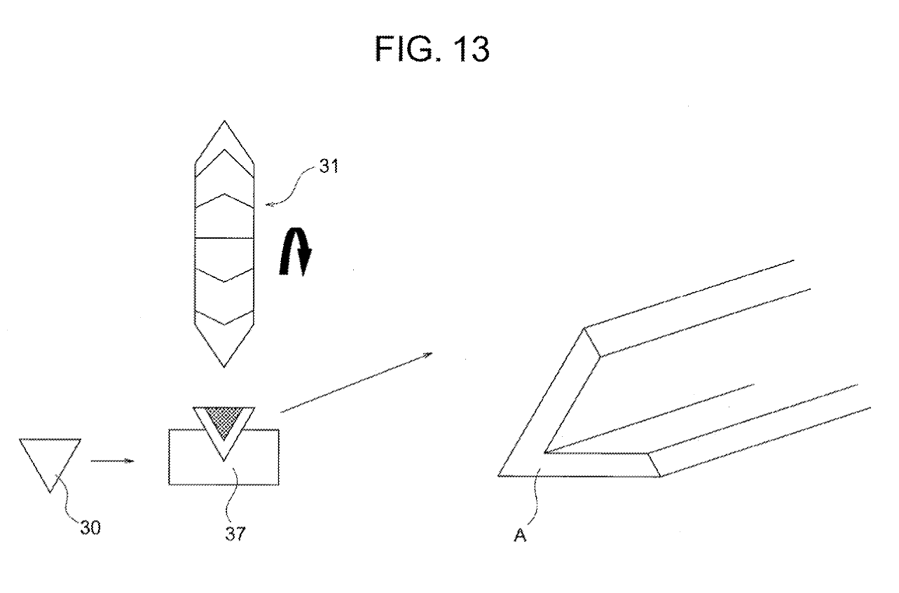

In FIG. 1, the reference symbol A denotes a first V-shaped longitudinal member produced by methods of FIG. 12 and FIG. 13 described below. As illustrated in FIG. 5, a pair of a first connection surface 10 and a second connection surface 11 are provided at both ends of the first V-shaped longitudinal member A, respectively, and are formed so that a first surface direction 12 of the first connection surface 10 and a second surface direction 13 of the second connection surface 11 are the same direction.

A second V-shaped longitudinal member B is combined with the above-mentioned first V-shaped longitudinal member A through a flat-plate-like longitudinal member C having a trapezoidal shape in cross-section. A first connection surface 14 and a second connection surface 15 are formed at both ends of the second V-shaped longitudinal member B, respectively.

The first connection surface 14 and the second connection surface 15 of the above-mentioned second V-shaped longitudinal member B are formed so that a first surface direction 16 of the first connection surface 14 and a second surface direction 17 of the second connection surface 15 are different directions.

Therefore, in the configuration illustrated in FIG. 1, first, in the right half of the configuration with respect to a center line E of FIG. 1, the first connection surface 10, i.e., one of the pair of the first connection surface 10 and the second connection surface 11 of the first V-shaped longitudinal member A, is connected to the second connection surface 15 of the second V-shaped longitudinal member B through the flat-plate-like longitudinal member C, whereas the second connection surface 11, i.e., the other of the pair, is connected to the first connection surface 14 of the second V-shaped longitudinal member B.

Further, in the left half of the configuration with respect to the center line E of FIG. 1, the second connection surface 11, i.e., one of the pair of the first connection surface 10 and the second connection surface 11 of the first V-shaped longitudinal member A, is connected to the second connection surface 15 of the second V-shaped longitudinal member B through the flat-plate-like longitudinal member C, whereas the first connection surface 10, i.e., the other of the pair, is connected to the first connection surface 19 of the second V-shaped longitudinal member B.

The first V-shaped longitudinal members A and the second V-shaped longitudinal members B are partially joined and linearly connected to one another on the center line E which symmetrically divides a rod body F constituting a polygonal rod 20, and thus a columnar body 21 is formed. Angled portions 22 of the rod body F are situated at both ends of the columnar body 21, respectively, and the angled portion 22 situated in the upper portion of the rod body F is provided with a line guide 23 for guiding a fishing line (not shown).

Note that, the connection surfaces 10 and 11 of the first V-shaped longitudinal member A and the connection surface 14 of the second V-shaped longitudinal member B of the above-mentioned columnar body 21 are formed so that the surface directions of the connection surfaces 10, 11, and 14 are linearly continuous in front view, and a pair of a first hollow portion 24 and a second hollow portion 25 each having a trapezoidal shape are formed on both sides of the columnar body 21, respectively. Further, the columnar body 21 is formed so that its longitudinal direction is the same direction as a swinging direction X of the rod body F.

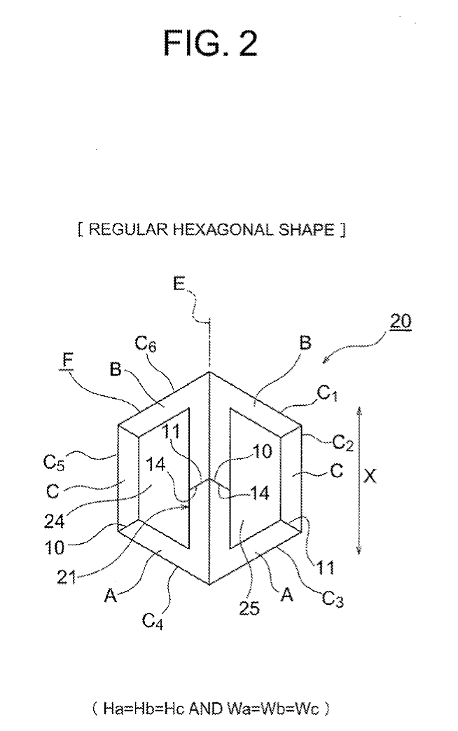

FIG. 2 illustrates a configuration of the rod body F constituting the polygonal rod 20 according to another embodiment of the polygonal rod of FIG. 1. Only portions different from those of FIG. 1 are described, and description of other portions is omitted. The connection surfaces 10 and 11 of the first V-shaped longitudinal member A and the connection surface 19 of the second V-shaped longitudinal member B of the above-mentioned columnar body 21 are formed so that the surface directions of the connection surfaces 10, 11, and 14 do not extend linearly unlike the above-mentioned case of the configuration of FIG. 1, but extend angularly, and the pair of first V-shaped longitudinal members A and A and the pair of second V-shaped longitudinal members B and B are situated at both the ends of the above-mentioned columnar body 21, respectively. Note that, the above-mentioned configuration of the polygonal rod 20 illustrated in FIG. 1 or FIG. 2 is formed into a regular hexagonal shape.

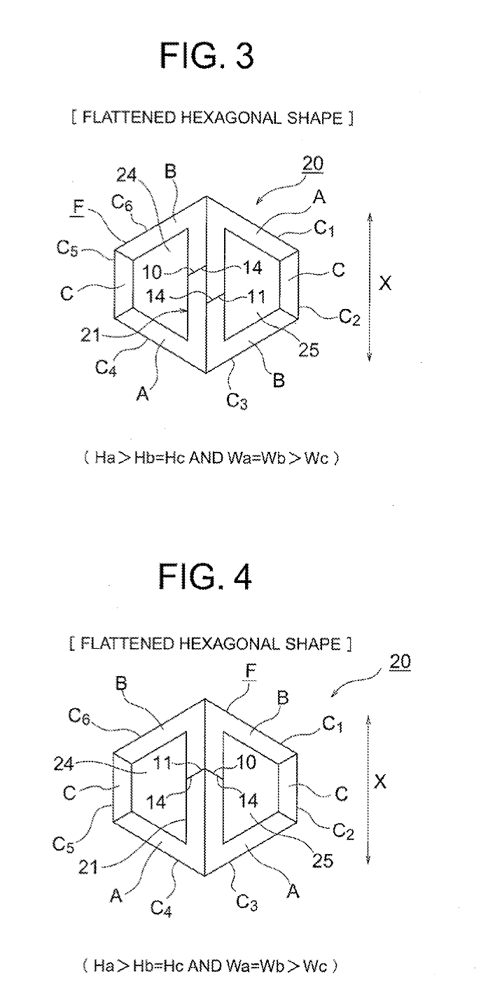

FIG. 3 illustrates a configuration of the polygonal rod 20 according to still another embodiment of the polygonal rod of FIG. 1. The polygonal rod of FIG. 3 does not have the regular hexagonal shape of FIG. 1, but has a flattened hexagonal shape. Only portions different from those of FIG. 1 are described, and description of other portions is omitted.

The first V-shaped longitudinal member A, the second V-shaped longitudinal member B, and the flat-plate-like longitudinal member C illustrated in FIG. 3 are connected and combined with one another in a similar way to that of FIG. 1. A part of each of the second V-shaped longitudinal members B and B is formed to have a length smaller than that of the configuration of FIG. 1. Thus, the surface directions of the connection surfaces 10, 11, and 14 are not continuous linearly or angularly unlike the above-mentioned case of FIG. 1 or FIG. 2, but are in a two-stage separate state.

In other words, in the embodiment of the polygonal rod 20 of FIG. 3, as to six sides C₁ to C₆ of the flattened hexagonal shape, the sides C₁, C₃, C₄, and C₆ are equal to one another, and the sides C₂ and C₅ are formed to be shorter than the other sides C₁, C₃, C₄, and C₆.

Note that, in the case of the rod body F constituting the above-mentioned polygonal rod 20 of FIG. 1 or FIG. 2 having the regular hexagonal shape, the sides C₁ to C₅ have the same length.

FIG. 4 illustrates a configuration of the rod body F constituting the polygonal rod 20 according to another embodiment of the configuration of the flattened hexagonal shape of FIG. 3. In the configuration of FIG. 4, the first V-shaped longitudinal members A and the second V-shaped longitudinal members B are provided similarly to the configuration of the regular hexagonal shape of FIG. 2, and the configurations of the connection surfaces 10, 11, and 14 of the columnar body 21 are similar to the above-mentioned configurations of FIG. 2.

Note that, other portions are configured similarly to the case of FIG. 2. Therefore, the same portions are denoted by the same reference symbols, and description thereof is omitted.

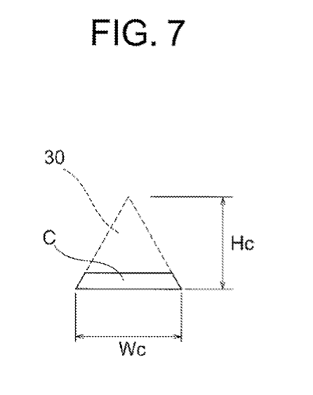

The above-mentioned first V-shaped longitudinal member A, second V-shaped longitudinal member B, and flat-plate-like longitudinal member C in each of the configurations of the rod body F constituting the polygonal rod 20 according to the present invention, which are disclosed in FIG. 1 to FIG. 4, are configured as illustrated in FIG. 5 to FIG. 7.

That is, the first V-shaped longitudinal member A of FIG. 5 is formed of a longitudinal member having a V-shape in cross-section. The configuration is made to satisfy the following condition for a first height Ha and a first width Wa of the above-mentioned first V-shaped longitudinal member A when the first connection surface 10 is arranged to be directed upward, a second height Hb and a second width Wb of the second V-shaped longitudinal member B when the first connection surface 14 of the second V-shaped longitudinal member B of FIG. 6 is arranged to be directed upward, and a third height Hc and a third width We of a trigonal longitudinal member 30 having a regular triangular shape in cross-section before the above-mentioned flat-plate-like longitudinal member C is formed.

Ha=Hb=Hc and Wa=Wb=Wc, or Ha>Hb=Hc and Wa=Wb>Wc

In other words, the polygonal rod 20 having the regular hexagonal shape of FIG. 1 or FIG. 2 satisfies the above-mentioned condition: Ha=Hb=Hc and Wa=Wb=Wc, whereas the polygonal rod 20 having the flattened hexagonal shape of FIG. 3 or FIG. 4 satisfies the above-mentioned condition: Ha>Hb=Hc and Wa=Wb>Wc.

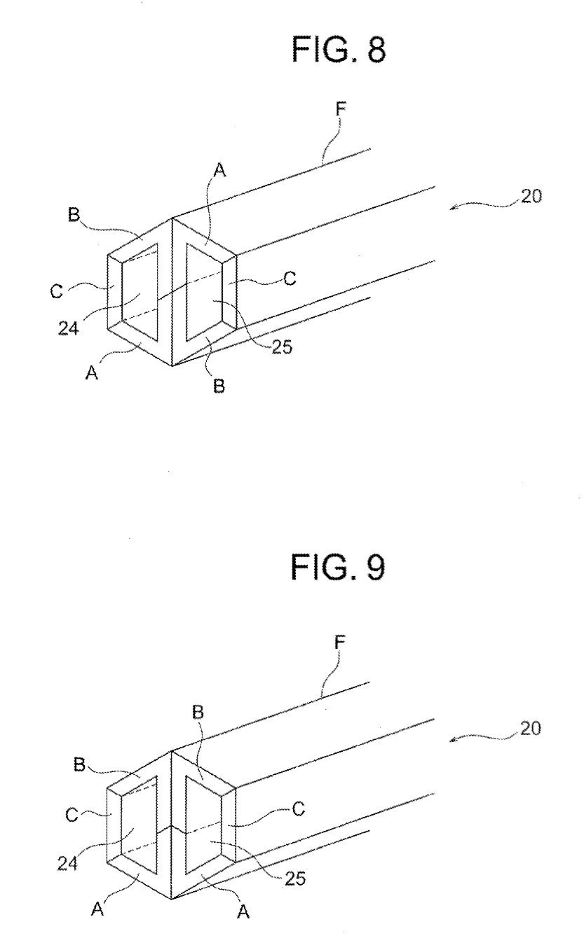

FIG. 8 illustrates a perspective view of the above-mentioned polygonal rod 20 of FIG. 1, and FIG. 9 illustrates a perspective view of the above-mentioned polygonal rod 20 of FIG. 2.

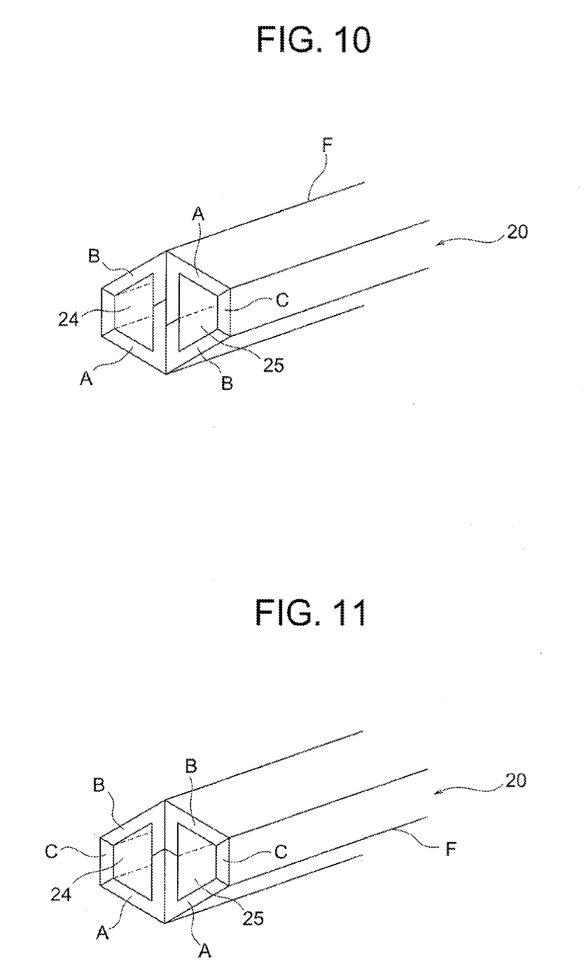

FIG. 10 illustrates a perspective view of the above-mentioned polygonal rod 20 of FIG. 3, and FIG. 11 illustrates a perspective view of the above-mentioned polygonal rod 20 of FIG. 4.

FIG. 12 and FIG. 13 illustrate a case of cutting the above-mentioned first V-shaped longitudinal member A. First, as illustrated in FIG. 12, the trigonal longitudinal member 30 having a regular triangular shape in cross-section is cut out by a cutting blade 32 including two combined angular cutters 31 each having an angle of 60°, and the trigonal longitudinal member 30 is cut by the angular cutter 31. Thus, the first V-shaped longitudinal member A can be produced.

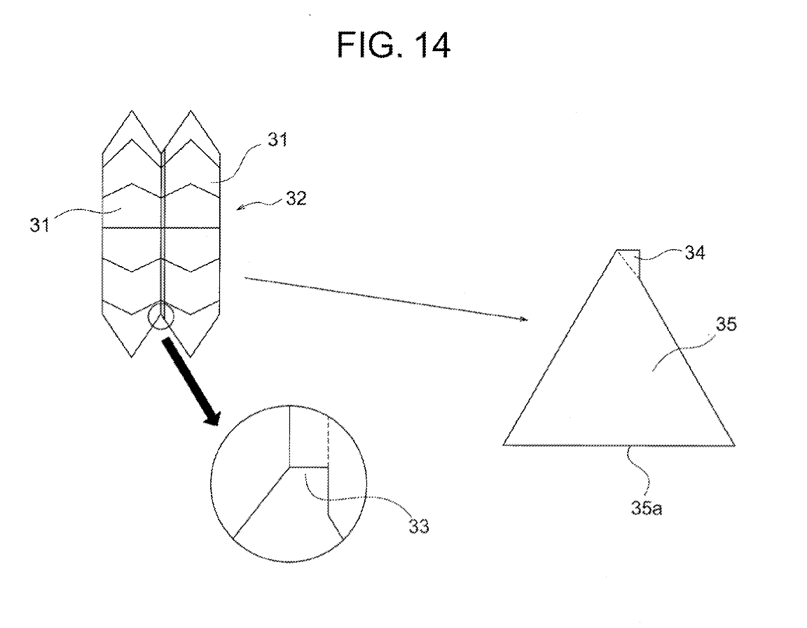

Next, FIG. 14 to FIG. 16 illustrate a case of cutting the above-mentioned second V-shaped longitudinal member B. First, as illustrated in FIG. 14, the two angular cutters 31 are combined together, and a material (not shown) is cut by the cutting blade 32 including a cut-out portion 33 formed by cutting out a shoulder portion of the angular cutter 31 to change an angle of the shoulder portion into 90°. As a result, a trigonal longitudinal member 35 with a protrusion having a protrusion 34 is obtained. Note that, a length of a base 35a of the trigonal longitudinal member 35 with a protrusion is equal to a length of a base of the first V-shaped longitudinal member A.

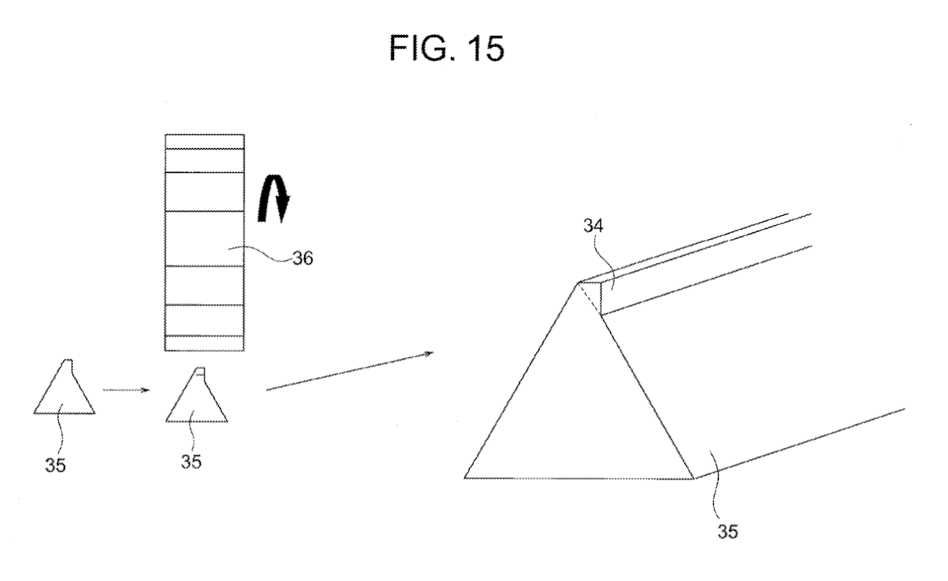

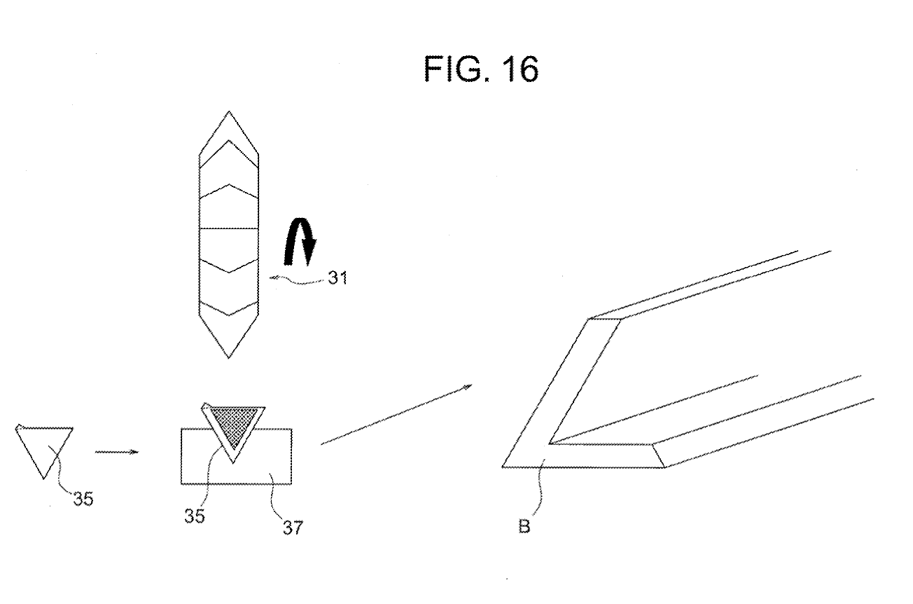

As illustrated in FIG. 15, the protrusion 34 of the above-mentioned trigonal longitudinal member 35 with a protrusion is cut by a flat blade 36, and then as illustrated in FIG. 16, the trigonal longitudinal member 35 with a protrusion is cut on a jig 37 by the angular cutter 31. Thus, the second V-shaped longitudinal member B can be produced.

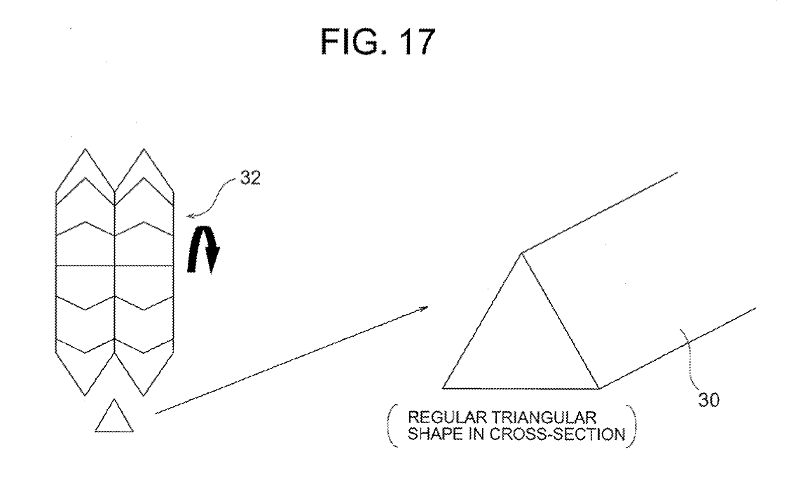

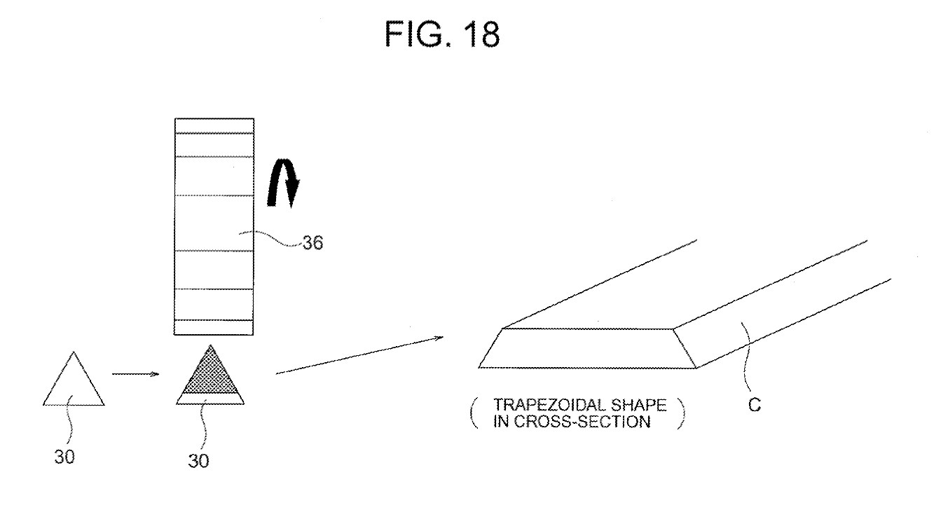

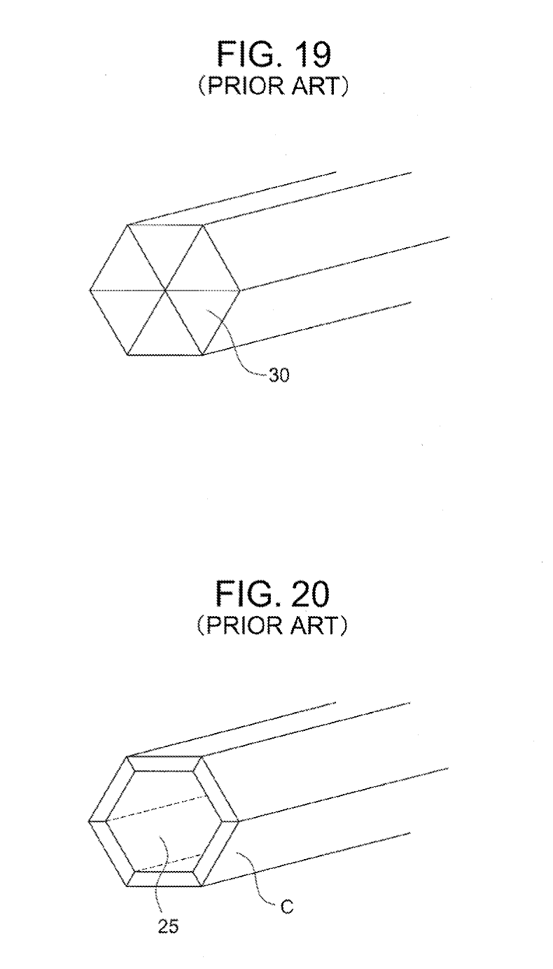

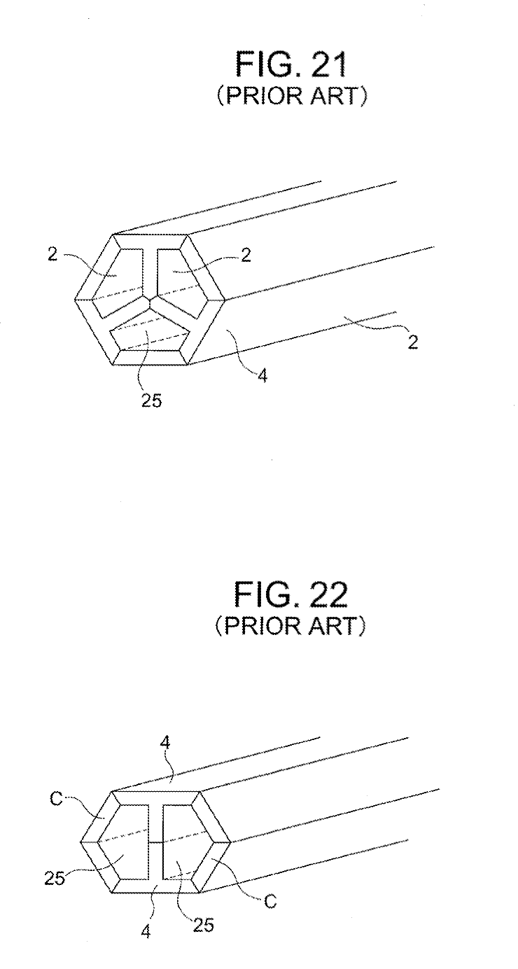

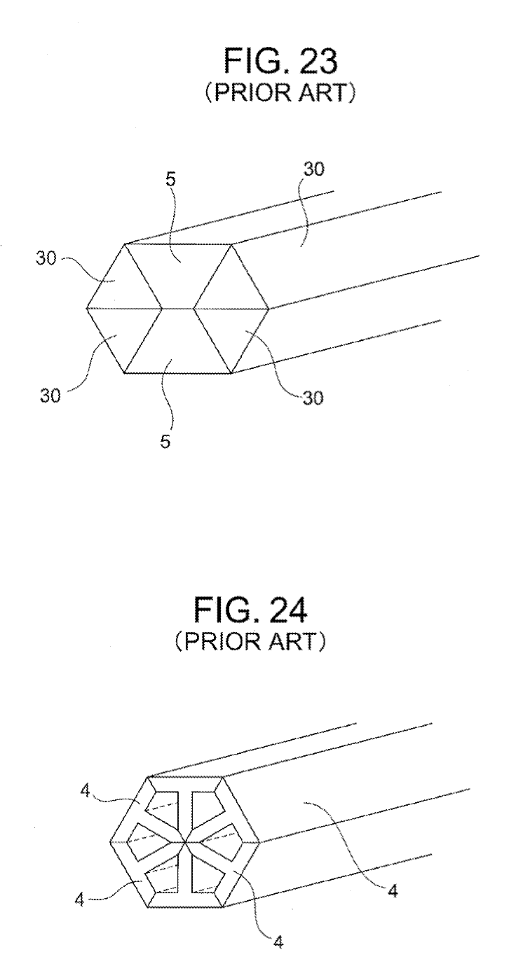

Next, FIG. 17 and FIG. 18 illustrate a case of cutting the flat-plate-like longitudinal member C having a trapezoidal shape in cross-section. The trigonal longitudinal member 30 having the triangular shape in cross-section is formed from a material (not shown) by the cutting blade 32 of FIG. 17, and the trigonal longitudinal member 30 is cut to a predetermined height by the flat blade 36 illustrated in FIG. 18. Thus, the flat-plate-like longitudinal member C can be produced.

The polygonal rod according to the present invention can have both a small weight and durability, and is applicable to rods in various fields.

1. A polygonal rod, which is formed into a longitudinal bar-like shape in overall view, and formed of a rod body (F) having an outer periphery formed into a polygonal shape in cross-section, the polygonal rod comprising at least four first and second V-shaped longitudinal members (A, B) each having a V-shape in cross-section, so as to form at least two hollow portions (24, 25),
wherein the at least four first and second V-shaped longitudinal members (A, B) are partially joined together to form a columnar body (21) having a linear shape, and
wherein angled portions (22) of the rod body (F) are situated at both ends of the columnar body (21), respectively.

2. A polygonal rod according to claim 1, further comprising a flat-plate-like longitudinal member (C) having a trapezoidal shape in cross-section between said four first and second V-shaped longitudinal members (A, B).

3. A polygonal rod according to claim 1, wherein surface directions (12, 13, 16, 17) of a pair of connection surfaces (10, 11, 14, 15) formed in each of said four first and second V-shaped longitudinal members (A, B) are one of the same direction and different directions.

4. A polygonal rod according to claim 1,
wherein the polygonal shape in cross-section comprises a hexagonal shape in cross-section, and
wherein all of sides (C₁ to C₆) of the hexagonal shape in cross-section are equal or only two sides (C₂, C₅) of the sides are shorter than the other sides (C₁, C₃, C₄, C₆).

5. A polygonal rod according to claim 1, wherein said the angled portion (22) has a line guide (23) for guiding a fishing line.

6. A polygonal rod according to claim 1,
wherein the first V-shaped longitudinal member (A) and the flat-plate-like longitudinal member (C) are formed by cutting a part of a trigonal longitudinal member (30) having a regular triangular shape in cross-section.

7. A polygonal rod according to claim 1, which is configured so as to satisfy the following condition for a first height (Ha) and a first width (Wa) of the first V-shaped longitudinal member (A) when a first connection surface (10) of the first V-shaped longitudinal member (A) is arranged to be directed upward, a second height (Hb) and a second width (Wb) of the second V-shaped longitudinal member (B) when a first connection surface (14) of the second V-shaped longitudinal member (B) is arranged to be directed upward, and a third height (Hc) and a third width (Wc) of the trigonal longitudinal member (30) having the regular triangular shape in cross-section before the flat-plate-like longitudinal member (C) is formed:
Ha=Hb=Hc and Wa=Wb=Wc, or Ha>Hb=Hc and Wa=Wb>Wc.

8. A polygonal rod according to claim 2, wherein surface directions (12, 13, 16, 17) of a pair of connection surfaces (10, 11, 14, 15) formed in each of said four first and second V-shaped longitudinal members (A, B) are one of the same direction and different directions.
